(19) United States
(12) Patent Application Publication
(10) Pub. No.: US 2007/0074409 A1
(43) Pub. Date: Apr. 5, 2007

(54) Pencil sharpener

(76) Inventors: Chia Wen Hsu, Taichang (TW); Michael A. Singleton, Warwick, RI (US)

Correspondence Address: Chia Wen Hsu, P.O. Box 2103, Taichung, TW

(21) Appl. No.: 11/239,039

(22) Filed: Sep. 30, 2005

(51) Int. Cl. B43L 23/00

(52) U.S. Cl. 30/451

(57) ABSTRACT

A pencil sharpener including housing, a rotary seat disposed in the housing, and a driver for rotationally driving the rotary seat. A blade unit includes two rotary blades that are disposed on the rotary seat and converge to define a sharpening angle. The sharpener also includes cooperating gears that rotate each blade about its associated longitudinal axis, and rotate the blades about a central axis therebetween. One of the rotary blades has a reduced diameter section, and the rotary seat has a projecting stop that corresponds to the reduced diameter section. The stop is positioned in a cavity of the rotary seat for the tip of a pencil to abut against so as to locate the pencil.

### BACKGROUND OF THE INVENTION

The present invention is related to a pencil sharpener, and more particularly to a pencil sharpener having double rotary blades. In which a pencil can be inserted in the pencil sharpener without being over-sharpened.

FIG. 7 shows a conventional pencil sharpener having a housing 8 in which a rotary seat 81 is pivotally installed. The rotary seat 81 has a cavity 811 corresponding with socket 80 of the housing 8. The other end of the rotary seat 81 is connected with a crank 82 for driving the rotary seat 81 to rotate. Two rotary blades 83, 84 are obliquely symmetrically disposed on two sides of the cavity 811 to contain a sharpening angle. One end of each rotary blade 83, 84 has a gear 831, 841 distal from the socket 80. The housing 8 has annularly arranged inner teeth 85 for engaging with the gears 83, 84. When a user cranks the crank 82, the rotary seat 81 is rotated to drive the rotary blades 83, 84 for sharpening a pencil.

The two rotary blades 83, 84 are obliquely symmetrically arranged, whereby the gap between the two rotary blades 83, 84 is tapered from the socket 80 to the crank 82. When sharpened, the pencil is pulled inward and milled into a sharp conic shape. However, in such structure, no stop structure is disposed between the rotary blades 83, 84 for stopping the pencil. Therefore, when sharpened, the pencil is often over-sharpened. In other words, a user cannot ascertain when the pencil is sharpened. In the case of an electric pencil sharpener, a pencil is more likely to be over-sharpened.

### SUMMARY OF THE INVENTION

It is therefore an aspect of the present invention to provide a pencil sharpener including two rotary blades. At least one of the blades has a small diameter section distal from the socket of the pencil sharpener. A rotary seat of the pencil sharpener has a projecting stop corresponding to the small diameter section. The stop is positioned in the cavity of the rotary seat for the tip of a pencil to abut against so as to locate the pencil.

According to an embodiment of the invention, the pencil sharpener of the present invention includes:

a housing having an internal receiving space and a socket inwardly extending toward the receiving space, the socket being constructed and arranged to receive a pencil;

a rotary seat disposed in the receiving space of the housing, the rotary seat having a cavity communicating with the socket;

a driver for rotationally driving the rotary seat;

a blade unit including a first rotary blade and a second rotary blade, the first and second rotary blades being disposed on the rotary seat and converging to define a sharpening angle; and,

cooperating gears that rotate each blade about its associated longitudinal axis, and that rotate the blades about a central axis therebetween, wherein the first of said rotary blades has a reduced diameter section, the rotary seat has a projecting stop corresponding to the reduced diameter section, the stop being positioned in the cavity for the tip of a pencil to abut against.

### BRIEF DESCRIPTION OF THE DRAWINGS

The present invention can be best understood through the following description and accompanying drawings wherein:

FIG. 1 is a perspective view of the present invention;

FIG. 2 is a sectional view showing the structure of the present invention;

FIG. 3 shows the assembly of the rotary seat, driving unit and blade unit of the present invention;

FIG. 4 is an enlarged view showing the application of the present invention;

FIG. 5 is a perspective view of another embodiment of the present invention;

FIG. 6 is a sectional view of the other embodiment of the present invention; and

FIG. 7 is a sectional view showing the structure of a conventional pencil sharpener.

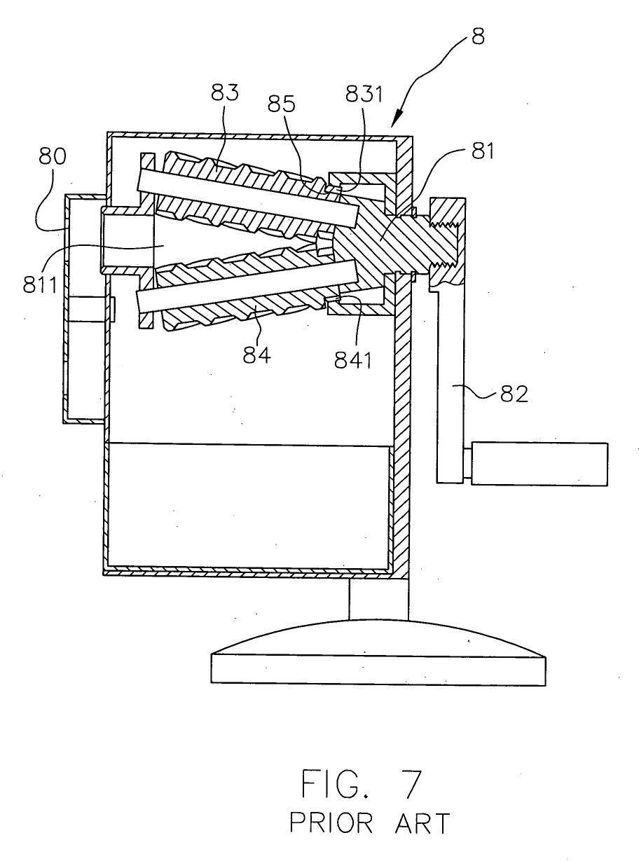

### DETAILED DESCRIPTION

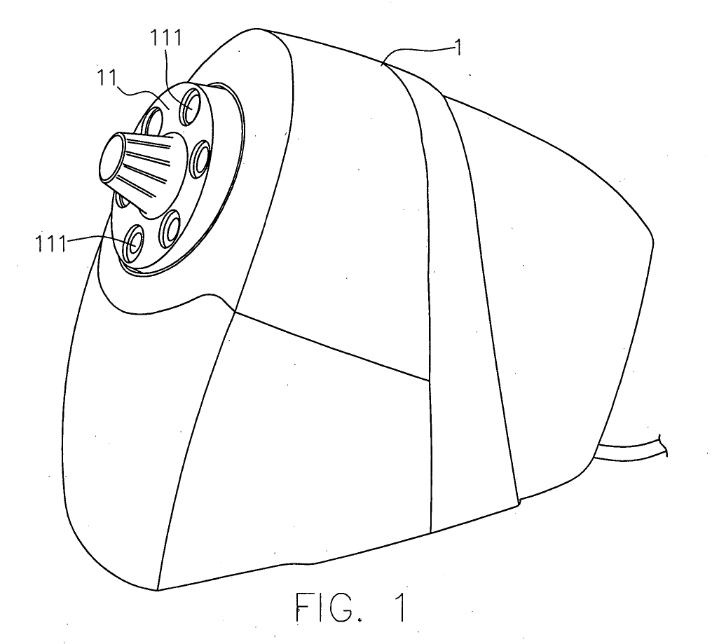

Please refer to FIGS. 1 to 3. According to an embodiment, the electric pencil sharpener of the present invention has a housing 1 and a rotary 11 disposed on one side of the housing 1. The rotary dial 11 is formed with several holes 111 with different diameters. Different diameters of pencils can be respectively inserted into the different holes 111 to be sharpened.

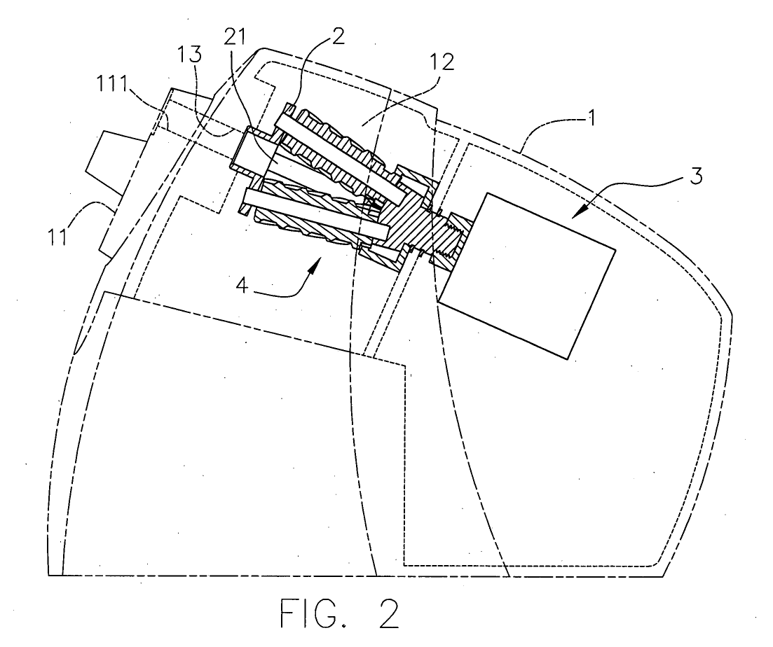

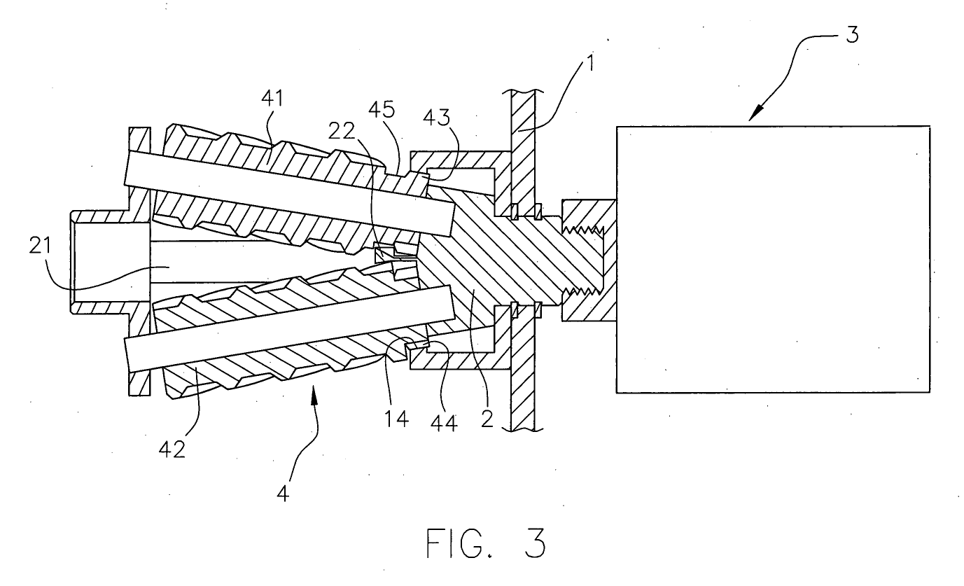

Referring to FIGS. 2 and 3, the housing 1 has an internal receiving space 12 and a socket 13 inwardly extending toward the receiving space 12. The socket 13 corresponds with the holes 111 of the rotary dial 11 and is constructed and arranged to receive a pencil.

A rotary seat 2 is rotatably disposed in the receiving space 12 of the housing 1. The rotary seat 2 has a cavity 21 coaxially communicating with the socket 13.

A driving mechanism 3, or driver, is connected with one end of the rotary seat 2 distal from the socket 13. In this embodiment, the driving mechanism 3 includes an electric motor unit for driving the rotary seat 2 to rotate.

A blade unit 4 is disposed on the rotary seat 2. The blade unit 4 has a first rotary blade 41 and a second rotary blade 42. The first and second rotary blades 41, 42 are pivotally disposed on the rotary seat 2 and obliquely symmetrically arranged on two sides of the cavity 21 to contain a sharpening angle. One end of each rotary blade 41, 42 has a first gear 43 and a second gear 44 distal from the socket 13. The housing 1 has annularly arranged inner teeth 14 for engaging with the first and second gears 43, 44. In operation, the first and second gears 43, 44 cooperate such that they rotate each blade 41, 42 about its associated longitudinal axis, and also rotate the first and second blades 41, 42 about a central axis therebetween via the annularly arranged inner teeth 14. The first and second gears 43, 44 and the annularly arranged inner teeth 14 may be collectively described as cooperating gears.

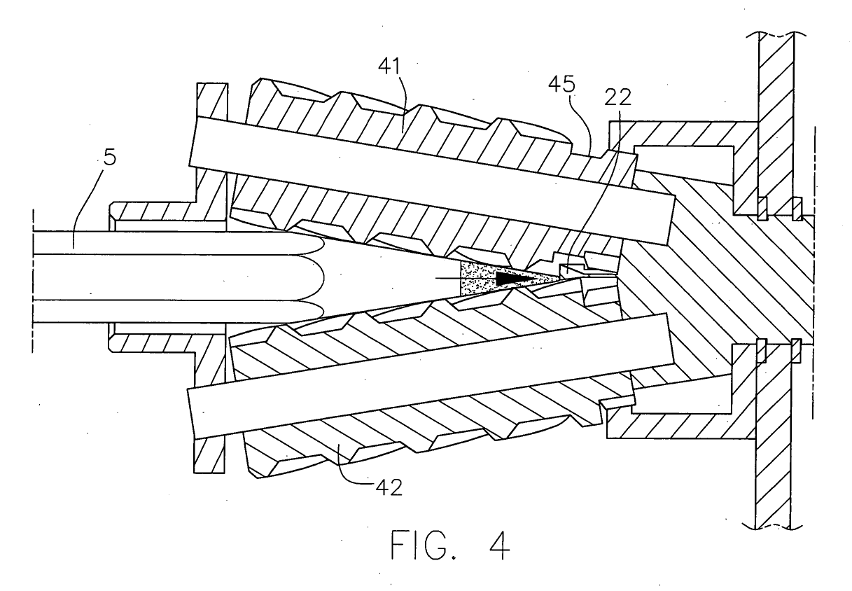

The first rotary blade 41 has a diameter section 45 distal from the socket 13 and adjacent to the first gear43, whereby a space is defined between the first and second rotary blades 41, 42. The rotary seat 2 has a projecting stop 22 corresponding to the reduced diameter section 45. The stop 22 is positioned in the cavity 21 for the tip of a pencil to abut against, as shown in FIG. 4. Accordingly, when sharpened, the pencil will not advance further inward by the first and second rotary blades 41, 42. Therefore, the pencil is located and prevented from being over-sharpened.

In another embodiment, the second rotary blade 42 also has a reduced diameter section distal from the socket 13 and adjacent to the second gear 44, and the rotary seat 2 has a projecting stop corresponding to the reduced diameter sections of both the first and second rotary blades 41, 42.

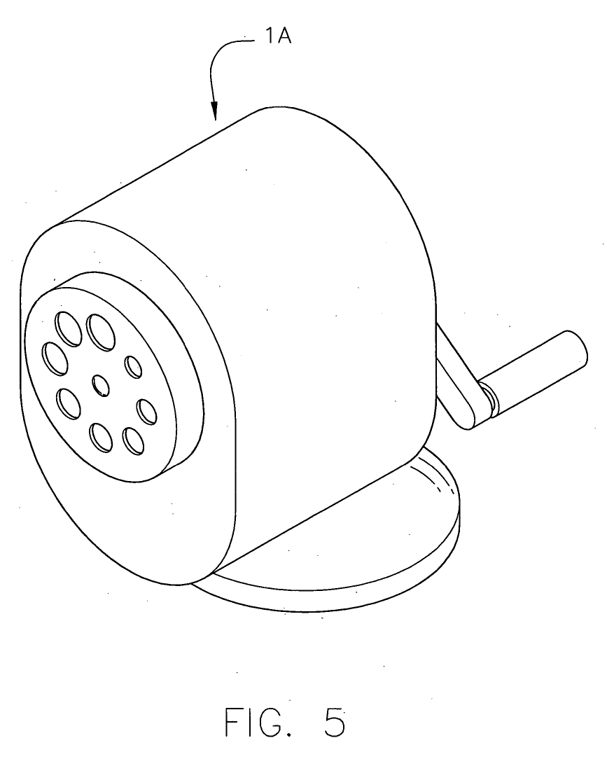

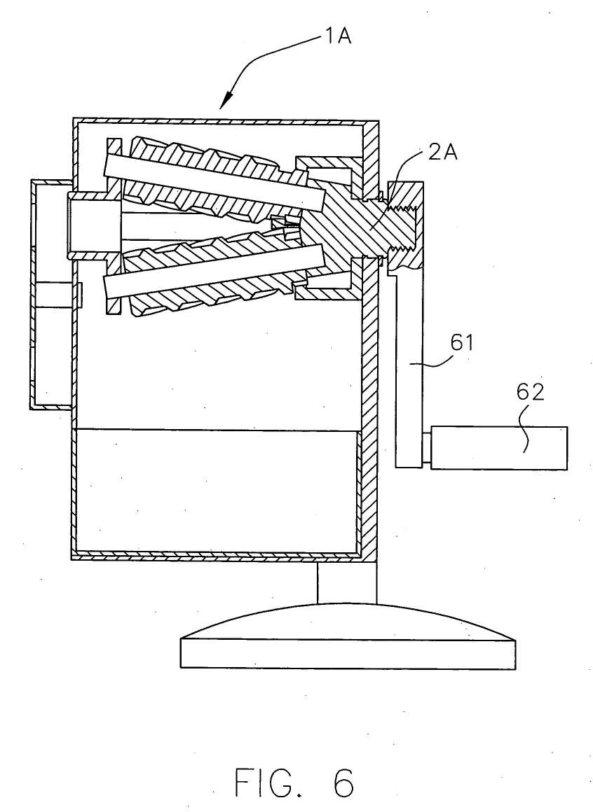

FIGS. 5 and 6 show another embodiment of the present invention, which is a manually operated pencil sharpener. The difference between the first and second embodiments is that in the second embodiment, the driver 6 includes a crank 61 connected with the rotary seat 2A. The crank has a handle 62 for driving the rotary seat to rotate. This can achieve same effect as the first embodiment.

The above embodiments are only used to illustrate the present invention, not intended to limit the scope thereof. Many modifications of above embodiments can be made without departing from the spirit of present invention.

What is claimed is:

1. A pencil sharpener comprising:
a housing having an internal receiving space and a socket inwardly extending toward the receiving space, the socket being constructed and arranged to receive a pencil;
a rotary seat disposed in the receiving space of the housing, the rotary seat having a cavity communicating with the socket;
a driver for rotationally driving the rotary seat;
a blade unit including a first rotary blade and a second rotary blade, the first and second rotary blades being disposed on the rotary seat and converging to define a sharpening angle; and
cooperating gears that rotate each blade about its associated longitudinal axis, and that rotate the blades about a central axis therebetween;
wherein the first of said rotary blades has a reduced diameter section, the rotary seat having a projecting stop corresponding to the reduced diameter section, the stop being positioned in the cavity for the tip of a pencil to abut against.

2. The pencil sharpener as claimed in claim 1, wherein the driver includes an electric motor unit for driving the rotary seat to rotate.

3. The pencil sharpener as claimed in claim 1, wherein the driver includes a crank connected with the rotary seat, the crank having a handle for driving the rotary seat to rotate.

4. The pencil sharpener as claimed in claim 1, wherein the rotary blades are pivotally disposed on the rotary seat and obliquely symmetrically arranged on two sides of the cavity to define the sharpening angle.

5. The pencil sharpener as claimed in claim 1, wherein the cooperating gears comprise a first gear disposed at a distal end of the first rotary blade relative to the socket, a second gear disposed at a distal end of the second rotary blade, and annularly arranged inner teeth for engaging with the first and second gears.

6. The pencil sharpener as claimed in claim 1, wherein the reduced diameter section is adjacent to one of the first and second gears.

7. The pencil sharpener as claimed in claim 1, wherein the second of said rotary blades has a reduced diameter section and the stop corresponds to the reduced diameter sections of the first and second rotary blades.
